(19) United States
(12) Patent Application Publication
(10) Pub. No.: US 2016/0190533 A1
(43) Pub. Date: Jun. 30, 2016

(54) ELECTRODE BODY

(71) Applicant: TOYOTA JIDOSHA KABUSHIKI KAISHA, Toyota-shi (JP)

(72) Inventor: Masakazu UMEHARA, Toyota-shi (JP)

(73) Assignee: TOYOTA JIDOSHA KABUSHIKI KAISHA, Toyota-shi (JP)

(21) Appl. No.: 14/972,872

(22) Filed: Dec. 17, 2015

(30) Foreign Application Priority Data
Dec. 26, 2014 (JP) 2014-264134

(51) Int. Cl. H01M 2/16; H01M 10/0525; H01M 10/04

(52) U.S. Cl. CPC H01M 2/166; H01M 2/1686; H01M 10/0431; H01M 10/0525

(57) ABSTRACT

An electrode body includes a positive and a negative electrode, and insulating layer. The positive electrode includes a positive electrode current collector and a positive electrode mixture layer formed both sides of the positive electrode current collector. The negative electrode includes a negative electrode current collector and a negative electrode mixture layer formed both sides of the negative electrode current collector. The insulating layer is provided between the positive and the negative electrode. The insulating layer includes a first and a second insulating layer. The first insulating layer contains ceramic particles and resin particles. A mass ratio of the ceramic particles to the resin particles is 100:0 to 50:50. The second insulating layer is formed of resin particles. The first insulating layer is arranged between the positive electrode mixture layer and the second insulating layer or between the negative electrode mixture layer and the second insulating layer.

### INCORPORATION BY REFERENCE

The disclosure of Japanese Patent Application No. 2014-264134 filed on Dec. 26, 2014 including the specification, drawings and abstract is incorporated herein by reference in its entirety.

### BACKGROUND OF THE INVENTION

1. Field of the Invention

The present invention relates to an electrode body and particularly to an electrode body which is used in a nonaqueous electrolyte secondary battery.

2. Description of Related Art

One of the nonaqueous electrolyte secondary batteries is a lithium ion secondary battery. The lithium ion secondary battery is chargeable or dischargeable by lithium ions in an electrolyte moving between a positive electrode and a negative electrode which store and release lithium ions.

Japanese Patent Application Publication No. 2013-080655 (JP 2013-080655 A) discloses a technique relating to a nonaqueous electrolyte secondary battery including an electrode plate, in which an insulating layer is formed by application on an electrode active material, as an electrode body. In the technique disclosed in JP 2013-080655 A, resin particles are used as particles constituting the insulating layer. Japanese Patent Application Publication No. 2013-127857 (JP 2013-127857 A) discloses an electrode body including an insulating layer in which inorganic particles and organic particles are mixed with each other.

In a case where an insulating layer of an electrode body is formed of resin particles as in the case of the nonaqueous electrolyte secondary battery disclosed in JP 2013-080655 A, when a load is applied to the electrode body, the resin particles may be crushed or deformed in an interface between an electrode mixture layer and the insulating layer. The reason for this is that the strength of the resin particles, which constitute the insulating layer, against the load is weaker than that of an electrode active material contained in the electrode mixture layer. When the resin particles are crushed as described above, the crushed resin particles enter into pores of the electrode mixture layer and cover a surface of the electrode active material. Therefore, the reaction area of the electrode active material decreases. When the resin particles are deformed, the contact area between the deformed resin particles and the electrode active material increases, and thus the reaction area of the electrode active material decreases. In this way, when the reaction area of the electrode active material decreases, the reaction resistance of the electrode body increases, which may decrease battery characteristics.

### SUMMARY OF THE INVENTION

The invention provides an electrode body in which an insulating layer is formed of resin particles.

An electrode body for a nonaqueous electrolyte secondary battery according to an aspect of the invention, includes a positive electrode including a positive electrode current collector and a positive electrode mixture layer formed both sides of the positive electrode current collector, a negative electrode including a negative electrode current collector and a negative electrode mixture layer formed both sides of the negative electrode current collector; and an insulating layer that is provided between the positive electrode and the negative electrode. The positive electrode, the insulating layer, and the negative electrode are laminated. The insulating layer includes a first insulating layer and a second insulating layer which are laminated. The first insulating layer contains ceramic particles and resin particles, a mass ratio of the ceramic particles to the resin particles is 100:0 to 50:50, The second insulating layer is formed of resin particles, and the first insulating layer is arranged between the positive electrode mixture layer and the second insulating layer or between the negative electrode mixture layer and the second insulating layer.

In the electrode body according to the aspect of the invention, the first insulating layer is provided between the second insulating layer, which is formed of resin particles, and the electrode mixture layer (a positive electrode mixture layer or a negative electrode mixture layer). In the first insulating layer, a mass ratio of the ceramic particles to the resin particles is 100:0 to 50:50. Therefore, even when a load is applied to the electrode body, the crushing or deformation of the first insulating layer (insulating layer containing ceramic particles) can be suppressed. Since the ceramic particles form a porous structure, the porous structure can be maintained in an interface between the electrode mixture layer and the first insulating layer (ceramic particles), and the reaction area of the electrode mixture layer (electrode active material) can be maintained. Accordingly, even when the insulating layer of the electrode body is formed of the resin particles, a decrease in battery characteristics (specifically, an increase in reaction resistance) can be suppressed.

According to the aspect of the invention, even when an insulating layer is formed of resin particles, an electrode body capable of suppressing a decrease in battery characteristics can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a top view showing an electrode body according to an embodiment;

FIG. 2 is a perspective view showing the electrode body according to the embodiment;

FIG. 3 is a sectional view showing the electrode body according to the embodiment;

FIG. 4 is a sectional view showing the electrode body according to the embodiment;

FIG. 5 is a sectional view showing another configuration example of the electrode body according to the embodiment;

FIG. 6 is a sectional view showing another configuration example of the electrode body according to the embodiment;

FIG. 7 is a sectional view showing another configuration example of the electrode body according to the embodiment;

FIG. 8 is a table showing a relationship between a configuration of an insulating layer and a reaction resistance ratio;

FIG. 9 is a table showing a relationship between a configuration of an insulating layer and a reaction resistance ratio; and

FIG. 10 is a sectional view showing an electrode body according to Comparative Example.

### DETAILED DESCRIPTION OF EMBODIMENTS

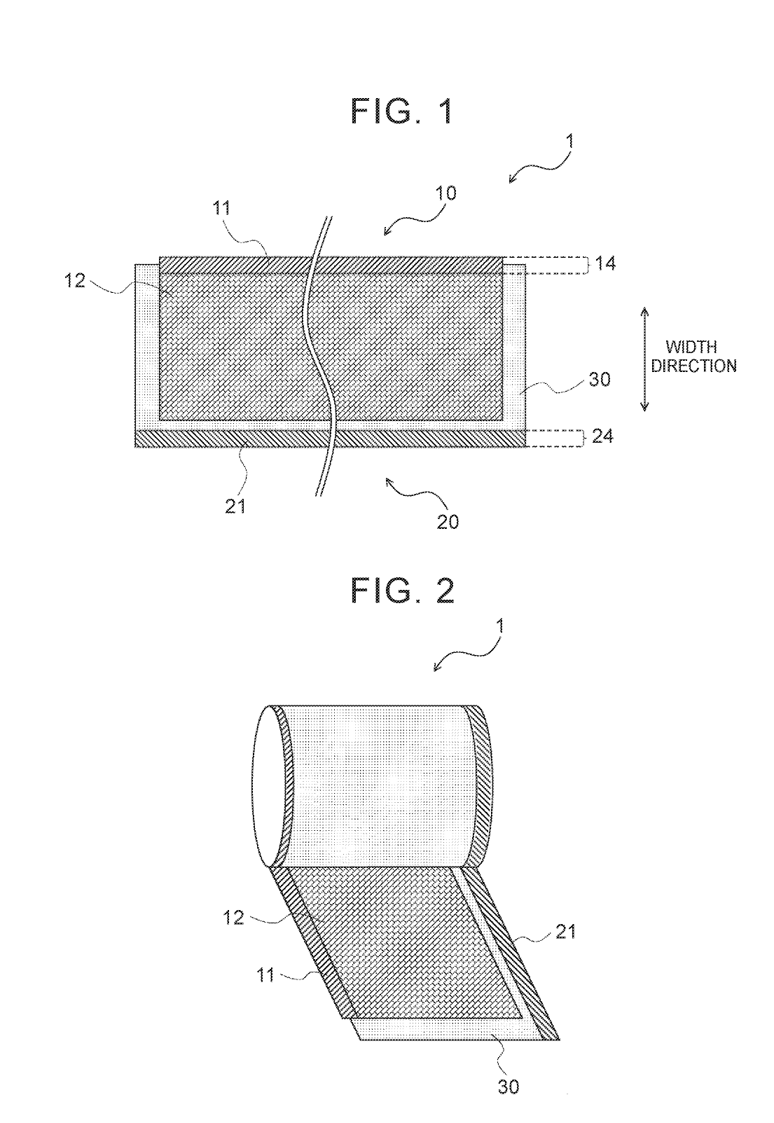

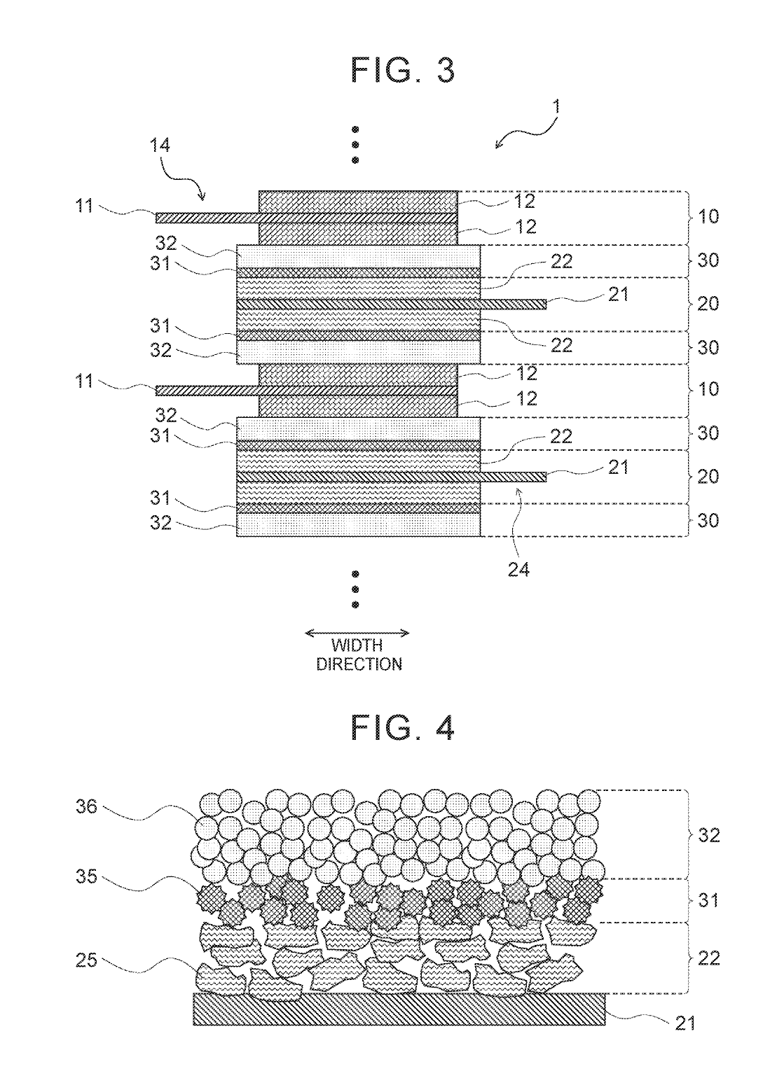

Hereinafter, an embodiment of the invention will be described with reference to the drawings. FIGS. 1 and 2 are a top view and a perspective view showing an electrode body 1 according to an embodiment of the invention, respectively. FIG. 1 shows a state of a positive electrode (positive electrode sheet) 10 and a negative electrode (negative electrode sheet) 20 before the electrode body 1 is wound. FIG. 2 shows a state where the electrode body 1 shown in FIG. 1 is being wound. FIG. 3 is a sectional view showing the electrode body 1 according to the embodiment, which is a sectional view in a laminating direction of the wound electrode body 1 shown in FIG. 2 (that is, a direction moving from a winding axis to an outer periphery of the wound electrode body 1).

As shown in FIGS. 1 to 3, the electrode body 1 according to the embodiment includes a belt-shaped positive electrode sheet 10 and a belt-shaped negative electrode sheet 20. An insulating layer 30 is arranged (formed by application) on both surfaces of the negative electrode sheet 20. As shown in FIGS. 1 and 2, the positive electrode sheet 10 and the negative electrode sheet 20 with both surfaces on which the insulating layer 30 is arranged are laminated and wound. As a result, as shown in FIG. 3, the wound electrode body 1 is formed in which the positive electrode sheet 10 and the negative electrode sheet 20 are laminated with the insulating layer 30. The insulating layer 30 is interposed between the positive electrode sheet 10 and the negative electrode sheet 20.

As shown in FIGS. 1 to 3, the positive electrode sheet 10 includes: a positive electrode current collector 11; and a positive electrode mixture layer 12 formed on the positive electrode current collector 11 (both surfaces of the positive electrode current collector 11). In an end of the positive electrode sheet 10 in a width direction thereof (that is, on an upper side of the positive electrode sheet 10 in FIG. 1), an exposure portion 14 where the positive electrode current collector 11 is exposed (that is, portion to which the positive electrode mixture layer 12 is not applied) is provided.

As the positive electrode current collector 11, for example, aluminum or an alloy containing aluminum as a major component can be used. The positive electrode mixture layer 12 contains a positive electrode active material. The positive electrode active material is a material capable of storing and releasing lithium, and for example, lithium cobalt oxide (LiCoO₂), lithium manganese oxide (LiMn₂O₄), or lithium nickel oxide (LiNiO₂), can be used. A material obtained by mixing LiCoO₂, LiMn₂O₄, and LiNiO₂ with each other at an arbitrary ratio and firing the obtained mixture may be used. The positive electrode mixture layer 12 may contain a conductive material. As the conductive material, for example, carbon blacks such as acetylene black (AB) or Ketjen black, and graphite can be used.

The positive electrode sheet 10 can be prepared, for example, by kneading the positive electrode active material, the conductive material, a solvent, and a binder with each other, applying the kneaded positive electrode mixture to the positive electrode current collector 11, and drying the positive electrode mixture. As the solvent, for example, N-methyl-2-pyrrolidone (NMP) can be used. As the binder, for example, polyvinylidene fluoride (PVdF), styrene-butadiene rubber (SBR), polytetrafluoroethylene (PTFE), or carboxymethyl cellulose (CMC) can be used.

As shown in FIGS. 1 to 3, the negative electrode sheet 20 includes: a negative electrode current collector 21; and a negative electrode mixture layer 22 formed on the negative electrode current collector 21 (both surfaces of the negative electrode current collector 21). In an end of the negative electrode sheet 20 in a width direction thereof (that is, on a lower side of the negative electrode sheet 20 in FIG. 1), an exposure portion 24 where the negative electrode current collector 21 is exposed (that is, portion to which the negative electrode mixture layer 22 is not applied) is provided.

As the negative electrode current collector 21, for example, copper, nickel, or an alloy thereof can be used. The negative electrode mixture layer 22 contains a negative electrode active material. The negative electrode active material is a material capable of storing and releasing lithium, and for example, a powdered carbon material formed of graphite or the like can be used. The negative electrode sheet 20 can be prepared, for example, by kneading the negative electrode active material, a solvent, and a binder with each other, applying the kneaded negative electrode mixture to the negative electrode current collector 21, and drying the negative electrode mixture (the same method as in the preparation of the positive electrode sheet 10 is used).

As shown in FIG. 3, the insulating layer 30 is arranged between the positive electrode sheet 10 and the negative electrode sheet 20. The insulating layer 30 functions as a separator which prevents short-circuiting between the positive electrode sheet 10 and the negative electrode sheet 20. As shown in FIG. 1, in the electrode body 1 according to the embodiment, the lengths of the negative electrode sheet 20 in longitudinal and width directions are longer than those of the positive electrode sheet 10. Accordingly, during the formation of the insulating layer 30, the insulating layer 30 is applied to both surfaces of the negative electrode sheet 20 (that is, to the negative electrode mixture layer 22). The wound electrode body 1 is formed by winding the negative electrode sheet 20, the insulating layer 30, and the positive electrode sheet 10 after laminating the negative electrode sheet 20, on which the insulating layer 30 is formed, and the positive electrode sheet 10.

As shown in FIG. 3, the insulating layer 30 includes a first insulating layer 31 and a second insulating layer 32. The first insulating layer 31 is formed of ceramic particles (in the first insulating layer 31, ceramic particles: resin particles=100:0 (mass ratio)). The ceramic particles are, for example, metal oxide particles such as alumina, magnesia, titania, or zirconia. The particle size of the ceramic particles constituting the first insulating layer 31 is, for example, from 0.5 μm to 3 μm inclusive.

The second insulating layer 32 is formed of resin particles. The resin particles are thermoplastic resin particles such as polyethylene particles. The particle size of the resin particles constituting the second insulating layer 32 is, for example, from 1 μm to 4 μm inclusive.

During the formation of the insulating layer 30, for example, the thickness of the first insulating layer 31 is from 2 μm to 5 μm inclusive, and the thickness of the second insulating layer 32 is from 5 μm to 30 μm inclusive. At this time, in order to maintain the insulating function of the insulating layer 30, the thickness of the insulating layer 30 (that is, the sum of the thickness of the first insulating layer 31 and the thickness of the second insulating layer 32) is from 10 μm to 35 μm inclusive.

In the embodiment, as shown in FIG. 3, the first insulating layer 31 is arranged in contact with the negative electrode mixture layer 22. FIG. 4 is a sectional view showing the electrode body according to the embodiment, which is an enlarged sectional view showing a portion where the negative electrode current collector 21, the negative electrode mixture layer 22, the first insulating layer 31, and the second insulating layer 32 are laminated. As shown in FIG. 4, the first insulating layer 31 is formed on the negative electrode mixture layer 22. That is, a negative electrode active material 25 contained in the negative electrode mixture layer 22 is arranged in contact with ceramic particles 35 constituting the first insulating layer 31. In other words, the first insulating layer 31 (ceramic particles 35) is arranged between the second insulating layer 32 (resin particles 36) and the negative electrode mixture layer 22 (negative electrode active material 25).

The second insulating layer 32 is formed of the resin particles 36 and thus functions as a so-called shutdown layer which interrupts a path of lithium ions by the resin particles 36 being melted when the electrode body 1 is heated to a high temperature.

The first insulating layer 31 is formed of the ceramic particles 35 having a strength which is equal to or higher than that of the negative electrode active material 25. Therefore, even when a load is applied to the electrode body 1, the crushing or deformation of the first insulating layer 31 can be suppressed. Since the ceramic particles 35 form a porous structure, the porous structure can be maintained in an interface between the negative electrode mixture layer 22 and the first insulating layer 31. Accordingly, since the reaction area of the negative electrode mixture layer 22 (negative electrode active material 25) can be maintained, a decrease in battery characteristics (specifically, an increase in reaction resistance) can be suppressed.

By providing the first insulating layer 31 (ceramic particles 35) between the second insulating layer 32 (resin particles 36) and the negative electrode mixture layer 22 (negative electrode active material 25), a decrease in battery characteristics can be suppressed even when the insulating layer 30 of the electrode body is formed of the resin particles 36 in order to maintain the shutdown function.

FIG. 10 is a sectional view showing an electrode body according to Comparative Example, which is a sectional view showing a state where a negative electrode current collector 121, a negative electrode mixture layer 122, and an insulating layer 130 are laminated. In Comparative Example shown in FIG. 10, the insulating layer 130 containing resin particles 131 is directly formed on the negative electrode mixture layer 122. In a case where the insulating layer 130 containing the resin particles 131 is directly formed on the negative electrode mixture layer 122 as described above, when a load 135 is applied to the electrode body, the resin particles 131 may be crushed or deformed in an interface between the negative electrode mixture layer 122 and the insulating layer 130. The reason for this is that the strength of the resin particles 131, which constitute the insulating layer 130, against the load is weaker than that of the negative electrode active material 125 contained in the negative electrode mixture layer 122. When the resin particles 131 are crushed, the crushed resin particles 132 enter into pores of the negative electrode mixture layer 122 and cover a surface of the negative electrode active material 125. Therefore, the reaction area of the negative electrode active material 125 decreases. When the resin particles 131 are deformed, the contact area between the deformed resin particles 133 and the negative electrode active material 125 increases, and thus the reaction area of the negative electrode active material 125 decreases. In this way, when the reaction area of the negative electrode active material 125 decreases, the reaction resistance of the electrode body increases, and there is a problem in that battery characteristics decrease.

On the other hand, in the electrode body according to the embodiment, as shown in FIG. 4, the first insulating layer 31 containing the ceramic particles 35 is provided between the second insulating layer 32 containing the resin particles 36 and the negative electrode mixture layer 22 containing the negative electrode active material 25. Therefore, even when a load is applied to the electrode body 1, the crushing or deformation of the first insulating layer 31 (ceramic particles 35) can be suppressed. Since the ceramic particles 35 form a porous structure, the porous structure can be maintained in an interface between the negative electrode mixture layer 22 and the first insulating layer 31, and the reaction area of the negative electrode mixture layer 22 (negative electrode active material 25) can be maintained. Accordingly, even when the insulating layer of the electrode body is formed of the resin particles, a decrease in battery characteristics can be suppressed.

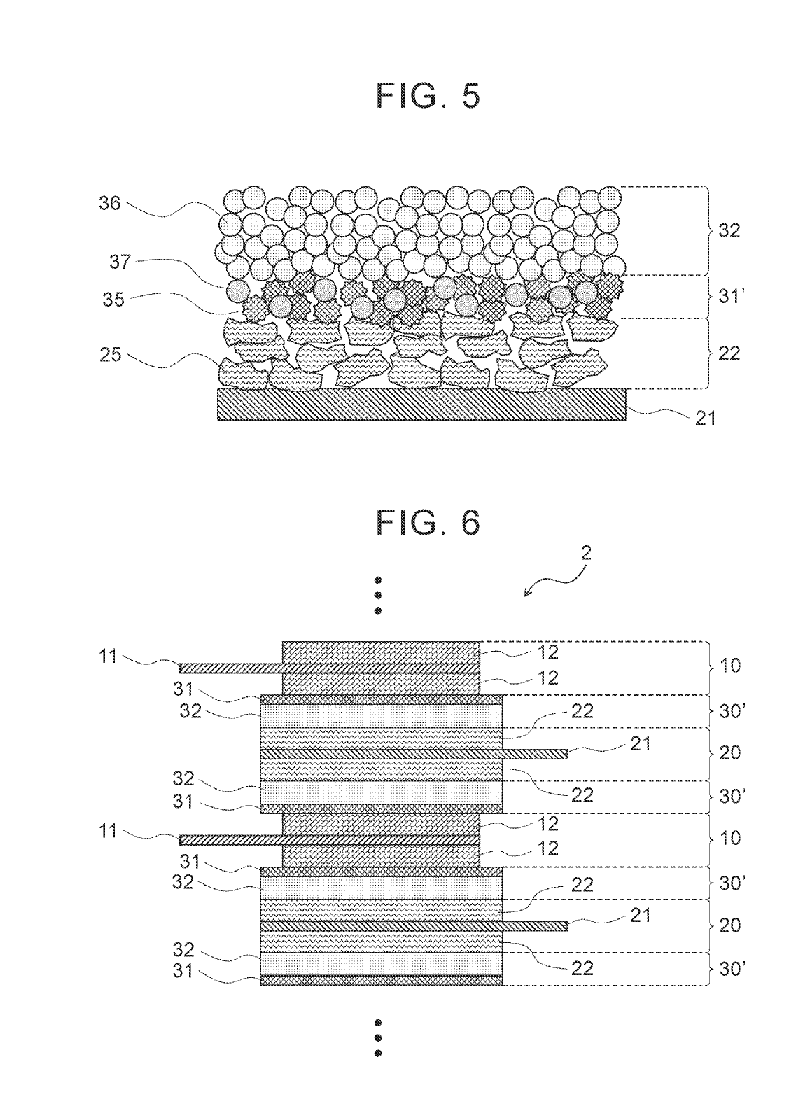

In the electrode body according to the embodiment, as shown in FIG. 5, a first insulating layer 31′ may be formed as a mixed layer in which the ceramic particles 35 and resin particles 37 are mixed with each other.

That is, in the embodiment, the first insulating layer 31 may not contain resin particles (refer to FIG. 4), or the first insulating layer 31′ may contain the resin particles 37 (refer to FIG. 5). At this time, the first insulating layer is configured such that a mass ratio of the ceramic particles to the resin particles is 100:0 to 50:50. In this way, by adjusting the amount of the ceramic particles 35 to be half or more (mass ratio) of the amount of the resin particles 37 in the first insulating layer 31 or 31′, an effect obtained by providing the first insulating layer 31 or 31′ containing the ceramic particles 35, that is, an effect of suppressing a decrease in battery characteristics is exhibited. When the mass ratio of the ceramic particles to the resin particles is 100:0, as shown in FIG. 4, the first insulating layer 31 consists of only the ceramic particles 35 (that is, does not contain the resin particles).

When the first insulating layer 31′ is a mixed layer containing the ceramic particles 35 and the resin particles 37, thermoplastic resin particles (for example, polyethylene particles) can be used as the resin particles 37. The particle size of the resin particles 37 constituting the first insulating layer 31′ is, for example, from 1 μm to 4 μm inclusive. During the formation of the first insulating layer 31, the same resin particles as the resin particles 36 constituting the second insulating layer 32 may be used as the resin particles 37.

During the formation of the first insulating layer 31′, by mixing different kinds of particles (the ceramic particles 35 and the resin particles 37) with each other as described above, the size and shape of particles constituting the first insulating layer 31′ can be made to vary. Accordingly, when the first insulating layer 31 consists of only the ceramic particles 35, the first insulating layer 31′ can be made to have a porous structure, and the number of paths of lithium ions can increase. Therefore, the reaction area of the negative electrode mixture layer 22 can increase. During the formation of the first insulating layer 31′, it is preferable that the mass ratio of the ceramic particles 35 to the resin particles 37 is 52:48 to 50:50. By adjusting the mass ratio of the ceramic particles 35 to the resin particles 37 to be within the above-described range, the crushing of the resin particles 37 can be suppressed, and the above-described effect can be particularly significantly exhibited.

In addition, referring to FIGS. 1 to 5, the case where the first insulating layer 31 is arranged in contact with the negative electrode mixture layer 22, that is, the case where the first insulating layer 31 is arranged between the negative electrode mixture layer 22 and the second insulating layer 32 has been described. However, in the electrode body according to the embodiment, as in the case of an electrode body 2 shown in FIG. 6, the first insulating layer 31 may be configured to be in contact with the positive electrode mixture layer 12. In other words, the first insulating layer 31 may be arranged between the positive electrode mixture layer 12 and the second insulating layer 32.

In the electrode body 2 having the configuration shown in FIG. 6, during the formation of the insulating layer 30′, the insulating layer 30′ is formed on both surfaces of the negative electrode sheet 20 (that is, on the negative electrode mixture layer 22). Specifically, the second insulating layer 32 is formed on the negative electrode mixture layer 22 of the negative electrode sheet 20, and the first insulating layer 31 is formed on the second insulating layer 32, thereby forming the insulating layer 30′. The wound electrode body 2 having the structure shown in FIG. 6 can be formed by winding the negative electrode sheet 20, the insulating layer 30′ and the positive electrode sheet 10 after laminating the negative electrode sheet 20, on which the insulating layer 30′ is formed, and the positive electrode sheet 10.

The effect of the electrode body 2 shown in FIG. 6 (the electrode body in which the first insulating layer 31 is arranged in contact with the positive electrode mixture layer 12) are the same as the effect of the electrode body 1 shown in FIG. 3 (the electrode body in which the first insulating layer 31 is arranged in contact with the negative electrode mixture layer 22). Since the pore size of the negative electrode mixture layer 22 is greater than that of the positive electrode mixture layer 12, the resin particles constituting the insulating layer are likely to enter into pores of the negative electrode mixture layer 22. Accordingly, in the electrode body 1 shown in FIG. 3 (the electrode body in which the first insulating layer 31 is arranged in contact with the negative electrode mixture layer 22), the effect of the invention, that is, the effect of suppressing a decrease in battery characteristics is more significant than in the electrode body 2 shown in FIG. 6 (the electrode body in which the first insulating layer 31 is arranged in contact with the positive electrode mixture layer 12).

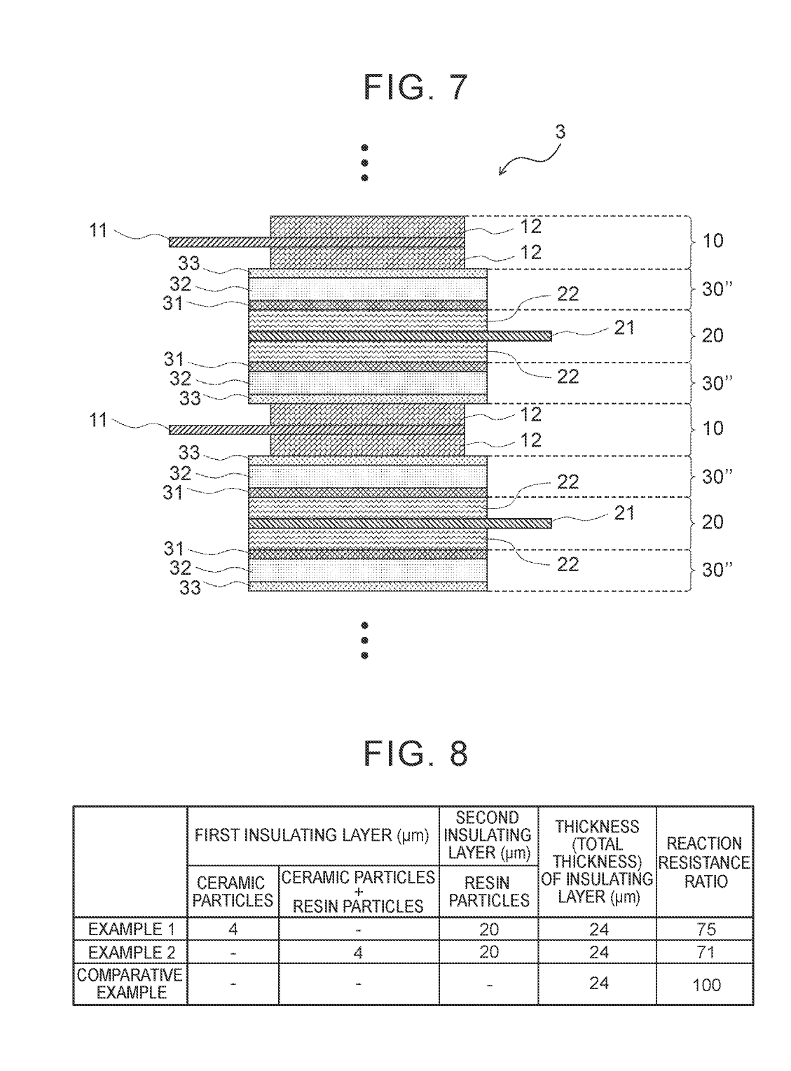

In the embodiment, when an insulating layer 30″ is configured as in the case of an electrode body 3 shown in FIG. 7, a third insulating layer 33 may be further provided on a side of the second insulating layer 32 opposite the first insulating layer 31. That is, the insulating layer 30″ may have a three-layer structure including the first to third insulating layers 31, 32, 33. The third insulating layer 33 is formed of ceramic particles. The material constituting the third insulating layer 33 and the thickness thereof can be made to be the same as the material constituting the first insulating layer 31 and the thickness thereof. The third insulating layer 33 may be formed by mixing ceramic particles and resin particles with each other as in the case of the first insulating layer 31′ shown in FIG. 5.

As shown in FIG. 7, during the formation of the insulating layer 30″, the insulating layer 30″ is formed on both surfaces of the negative electrode sheet 20 (that is, on the negative electrode mixture layer 22). Specifically, the first insulating layer 31 is formed on the negative electrode mixture layer 22 of the negative electrode sheet 20, the second insulating layer 32 is formed on the first insulating layer 31, and the third insulating layer 33 is formed on the second insulating layer 32, thereby forming the insulating layer 30″. The wound electrode body 3 having the structure shown in FIG. 7 can be formed by winding the negative electrode sheet 20, the insulating layer 30″ and the positive electrode sheet 10 after laminating the negative electrode sheet 20, on which the insulating layer 30″ is formed, and the positive electrode sheet 10.

In the electrode body 3 shown in FIG. 7, the first insulating layer 31 is formed between the negative electrode mixture layer 22 and the second insulating layer 32, and the third insulating layer 33 is formed between the positive electrode mixture layer 12 and the second insulating layer 32. Accordingly, in both of an interface between the negative electrode mixture layer 22 and the first insulating layer 31 and an interface between the positive electrode mixture layer 12 and the third insulating layer 33, a porous structure can be maintained, and the reaction area in each mixture layer can be maintained. Accordingly, in the electrode body 3 shown in FIG. 7, the effect of the invention, that is, the effect of suppressing a decrease in battery characteristics is particularly significant.

According to the above-described embodiment, even when an insulating layer is formed of resin particles, an electrode body capable of suppressing a decrease in battery characteristics can be provided.

JP 2013-127857 A discloses an electrode body including an insulating layer in which inorganic particles and organic particles are mixed with each other. However, the insulating layer included in the electrode body disclosed in JP 2013-127857 A is an insulating layer (mixed layer) in which inorganic particles and organic particles are mixed with each other, and this configuration is different from that of the insulating layer 30 (including the first insulating layer 31 and the second insulating layer 32) included in the electrode body (in particular, refer to FIGS. 3 to 5) according to the embodiment. In the embodiment, the configuration in which the first insulating layer 31′ is a mixed layer is also described (refer to FIG. 5). However, in the i embodiment, the second insulating layer 32 formed of the resin particles 36 is further formed on the first insulating layer 31′ (mixed layer), and thus this configuration is different from that of the electrode body disclosed in JP 2013-127857 A.

In particular, in the embodiment, the ceramic particles are predominantly arranged on an interface between the electrode mixture layer and the insulating layer (that is, the ceramic particles are concentrated in an interface between the electrode mixture layer and the insulating layer; refer to FIGS. 4 and 5). Therefore, a porous structure can be maintained in the interface between the electrode mixture layer and the insulating layer. Accordingly, since the reaction area of the electrode mixture layer (electrode active material) can be maintained, a decrease in battery characteristics can be suppressed. In this way, t the embodiment is different from the invention disclosed in JP 2013-127857 A. Therefore, the problems to be solved by the invention cannot be solved by the technique disclosed in JP 2013-127857 A.

Next, Examples of the invention will be described. Using the above-described method, electrode bodies according to Examples were formed. In Example 1, a sample was prepared in which the first insulating layer 31 was formed of ceramic particles (alumina particles) as in the case of the electrode body shown in FIG. 4. At this time, the thickness of the first insulating layer 31 was 4 μm, and carboxymethyl cellulose (CMC) was used as a binder. The composition ratio (mass ratio) of the first insulating layer 31 was alumina particles: CMC=99.8:0.2. The particle size of the alumina particles was 0.5 μm to 3 μm. The second insulating layer 32 was formed of polyethylene particles. The thickness of the second insulating layer 32 was 20 μm, and the composition ratio (mass ratio) of the second insulating layer 32 was polyethylene particles: CMC=99.8:0.2. The particle size of the polyethylene particles was 1 μm to 4 μm. The total thickness of the insulating layer in Example 1 was 24 μm.

In Example 2, a sample was prepared in which the first insulating layer 31′ was formed of ceramic particles (alumina particles) and resin particles (polyethylene particles) as in the case of the electrode body shown in FIG. 5. At this time, the thickness of the first insulating layer 31′ was 4 μm, and carboxymethyl cellulose (CMC) was used as a binder. The composition ratio (mass ratio) of the first insulating layer 31′ was alumina particles: polyethylene particles: CMC=51.96:47.38:0.67. In the first insulating layer, the mass ratio of the alumina particles to the polyethylene particles was about 1.1. The particle size of the alumina particles was 0.5 μm to 3 μm. The second insulating layer 32 was formed of polyethylene particles. The thickness of the second insulating layer 32 was 20 μm, and the composition ratio (mass ratio) of the second insulating layer 32 was polyethylene particles: CMC=99.8:0.2. The particle size of the polyethylene particles was 1 μm to 4 μm. The total thickness of the insulating layer in Example2 was 24 μm.

In Comparative Example, a sample was prepared in which the insulating layer 130 was formed of resin particles (polyethylene particles) as in the case of the electrode body shown in FIG. 10. At this time, the thickness of the insulating layer 130 was 24 μm, and carboxymethyl cellulose (CMC) was used as a binder. The composition ratio (mass ratio) of the insulating layer 130 was polyethylene particles: CMC=99.8:0.2. The particle size of the polyethylene particles was 1 μm to 4 μm.

The electrode bodies according to Examples 1 and 2 and Comparative Example described above were formed. Using the electrode bodies, lithium ion secondary batteries were prepared. The impedance of each of the lithium ion secondary batteries was measured at −30° C. to measure the reaction resistance. Specifically, an arc portion as a reaction resistance was measured in a Nyquist plot at a frequency of 0.01 kHz to 100 kHz and SOC of 100% (4.1 V). When the reaction resistance of Comparative Example was represented by 100, reaction resistance ratios of Examples 1 and 2 were obtained.

FIG. 8 shows a relationship between the configuration of the insulating layer and the reaction resistance ratio in each of the samples according to Examples 1 and 2 and Comparative Example. As shown in FIG. 8, the reaction resistance ratios of Examples 1 and 2 were lower than that of Comparative Example. Therefore, an increase in reaction resistance was able to be suppressed by providing the first insulating layer containing the alumina particles between the second insulating layer (polyethylene particles) and the negative electrode mixture layer (negative electrode active material).

The reaction resistance ratio of Example 1 was 75, whereas the reaction resistance ratio of Example 2 was 71. Therefore, in Example 2 in which the first insulating layer was formed by mixing the ceramic particles (alumina particles) and the resin particles (polyethylene particles) with each other, the reaction resistance ratio was lower than that in Example 1 in which the first insulating layer consisted of only the ceramic particles (alumina particles).

The reason for this is presumed to be as follows. In Example 2, during the formation of the first insulating layer, by mixing different kinds of particles (the alumina particles and the polyethylene particles) with each other as described above, the size and shape of particles constituting the first insulating layer was able to be made to vary. As a result, the number of pores in the first insulating layer increased, and the number of paths of lithium ions was able to increase.

Samples were prepared while changing the thickness of the first insulating layer and the thickness of the second insulating layer. Specifically, samples in which the first insulating layer consisted of only alumina particles were prepared using the same method as in Example 1, and the thickness of the first insulating layer and the thickness of the second insulating layer were changed, respectively. As a result, samples (Examples 1-1 to 1-6) were prepared. The configurations (except for the thickness) of the first and second insulating layers were the same as those in Example 1.

Specifically, samples in which the first insulating layer were formed of alumina particles and polyethylene particles were prepared using the same method as in

Example 2, and the thickness of the first insulating layer and the thickness of the second insulating layer were changed, respectively. As a result, samples (Examples 2-1 to 2-6) were prepared. The configurations (except for the thickness) of the first and second insulating layers were the same as those in Example 2.

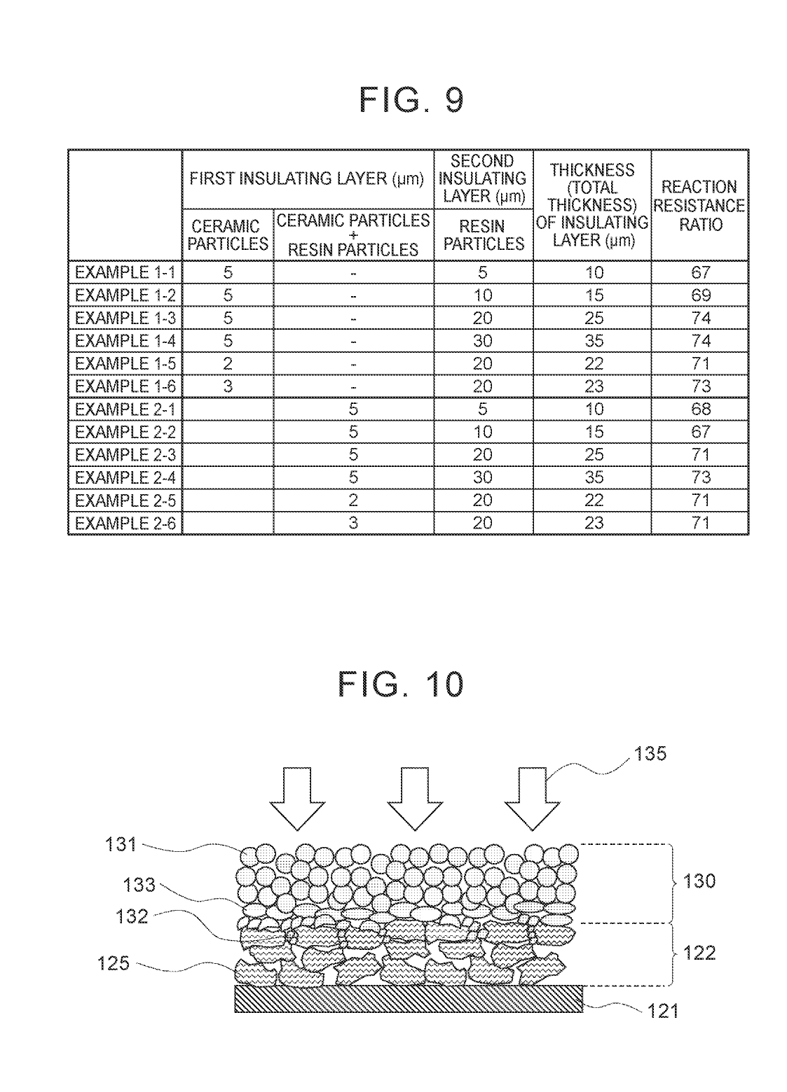

FIG. 9 shows a relationship between the configuration of the insulating layer and the reaction resistance ratio in each of the samples according to Examples 1-1 to 1-6 and Examples 2-1 to 2-6. As shown in FIG. 9, in each of Examples 1-1 to 1-6 and Examples 2-1 to 2-6, as the thickness (total thickness) of the insulating layer increased, the reaction resistance ratio increased. The reason for this is presumed to be as follows: as the thickness of the insulating layer increased, transfer characteristics of lithium ions decreased.

As a result of comparison between Examples 1-2 and 2-2 in which the thicknesses of the insulating layers were the same, it was found that the reaction resistance ratio was lower in Example 2-2 in which the first insulating layer was formed of the alumina particles and the polyethylene particles. The same shall be applied to the results of comparison between Examples 1-3 and 2-3, the results of comparison between Examples 1-4 and 2-4, and the results of comparison between Examples 1-6 and 2-6. That is, it is presumed that, in the case where the first insulating layer was formed by mixing different kinds of particles (the alumina particle and the polyethylene particle) with each other as described above, the number of pores in the first insulating layer was more than that in the case where the first insulating layer consisted of only alumina particles, and the number of paths of lithium ions increased, which decreases the reaction resistance ratio.

Hereinabove, the invention has been described using the embodiment and Examples. However, the invention is not limited to the above-described configurations of the embodiment and Examples. As long as, a decrease in battery characteristics can be suppressed, the above-described embodiments and Examples may be appropriately modified, altered, or combined with each other.

What is claimed is:

1. An electrode body for a nonaqueous electrolyte secondary battery, the electrode body comprising:
a positive electrode including a positive electrode current collector and a positive electrode mixture layer formed both sides of the positive electrode current collector;
a negative electrode including a negative electrode current collector and a negative electrode mixture layer formed both sides of the negative electrode current collector; and
an insulating layer that is provided between the positive electrode and the negative electrode, wherein
the positive electrode, the insulating layer, and the negative electrode are laminated,
the insulating layer includes a first insulating layer and a second insulating layer which are laminated,
the first insulating layer contains ceramic particles and resin particles,
a mass ratio of the ceramic particles to the resin particles in the first insulating layer is 100:0 to 50:50,
the second insulating layer is formed of resin particles, and
the first insulating layer is arranged between the positive electrode mixture layer and the second insulating layer or between the negative electrode mixture layer and the second insulating layer.

2. The electrode body according to claim 1, wherein
the first insulating layer is a mixed layer in which the ceramic particles and the resin particles are mixed with each other.

3. The electrode body according to claim 2, wherein
in the first insulating layer, the mass ratio of the ceramic particles to the resin particles is 52:48 to 50:50.

4. The electrode body according to claim 1, wherein
a thickness of the first insulating layer is greater than or equal to 2 μm and smaller than or equal to 5 μm,
a thickness of the second insulating layer is greater than or equal to 5 μm and smaller than or equal to 30 μm, and
a thickness of the insulating layer including the first insulating layer and the second insulating layer is greater than or equal to 10 μm and smaller than or equal to 35 μm.

5. The electrode body according to claim 1, wherein
a particle size of the ceramic particles is greater than or equal to 0.5 μm and smaller than or equal to 3 μm, and
a particle size of the resin particles is greater than or equal to 1 μm and smaller than or equal to 4 μm.

6. The electrode body according to claim 1, wherein
the first insulating layer is formed between the negative electrode mixture layer and the second insulating layer.

7. The electrode body according to claim 6, wherein
a pore size of the negative electrode mixture layer is greater than a pore size of the positive electrode mixture layer.

8. The electrode body according to claim 1, wherein
the electrode body is a wound electrode body formed by laminating the positive electrode and the negative electrode with the insulating layer interposed therebetween to obtain a laminate and winding the laminate.

9. The electrode body according to claim 1, wherein
the negative electrode mixture layer contains a negative electrode active material, and
a strength of the ceramic particles is equal to or higher than a strength of the negative electrode active material.

10. The electrode body according to claim 1, wherein
the ceramic particles have a porous structure.

11. The electrode body according to claim 1, wherein
the insulating layer includes a third insulating layer,
the third insulating layer contains ceramic particles and resin particles,
a mass ratio of the ceramic particles to the resin particles in the third insulating layer is 100:0 to 50:50, and
the second insulating layer is arranged between the first insulating layer and the third insulating layer.
